(19) United States
(12) Patent Application Publication
(10) Pub. No.: US 2007/0018830 A1
(43) Pub. Date: Jan. 25, 2007

(54) Vehicle component tamper detection system

(75) Inventors: Narizane Inoue, Saitama (JP); Koichi Inaba, Saitama (JP); Tsuyoshi Eguchi, Saitama (JP); Tatsuya Okayama, Saitama (JP); Atsuhiro Miyauchi, Saitama (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD.

(21) Appl. No.: 11/476,132

(22) Filed: Jun. 28, 2006

(30) Foreign Application Priority Data
Jul. 20, 2005 (JP) 2005-210660

(51) Int. Cl. G08B 13/14

(52) U.S. Cl. 340/572.4

(57) ABSTRACT

A vehicle component tamper detection system is provided capable of appropriately preventing tampering from occurring, and of facilitating and ensuring detection of such tampering when it occurs, while maintaining flexibility in layout and in manufacturing processes. The present invention omits wiring between an RFID 12 and an ECU 14 by employing a small radio frequency identification integrated circuit (RFID) to wirelessly transmit signals to a receiver 13. With this configuration, the present invention contributes to increased layout flexibility as well as a reduction in assembly steps and manufacturing costs. Furthermore, because the RFID 12 is small, the RFID 12 may be mixed in slurry and disposed at an inconspicuous portion of a detection target component 11. Subsequently, it is possible to hinder visual confirmation of the RFID 12, thereby making the tampering itself difficult.

This application is based on and claims the benefit of priority from Japanese Patent Application No. 2005-210660, filed on 20 Jul. 2005, the content of which is incorporated herein by reference.

### BACKGROUND OF THE INVENTION

1. Field of the Invention

The present invention relates to a vehicle component tamper detection system for anti-tampering of a vehicle component of an automobile.

2. Related Art

Presently, with growing concerns about environmental problems, a study has been conducted on a technique of air quality improvement in which a radiator applied with a catalyst for causative agents of photochemical smog (such as ozone) is installed in a vehicle, and such a vehicle is driven. Simply driving this type of vehicle may purify the surrounding air, and thus, the environment may be improved.

However, in radiators such as these (e.g. a radiator coated with an ozone catalyst), just the cost of the portion that has been coated with the catalyst is expensive. In addition, radiators such as these can be easily replaced with a radiator of the same kind but without being coated with an ozone catalyst. The result of such replacement hardly affects the driving of the vehicle itself. However, any capability for purifying the air in the surrounding environment is completely absent.

In such cases, the fact that interchangeable components are very often used in the field of the automobile industry due to various advantages adversely poses the risk of fraudulent replacement or removal of a vehicle component. Moreover, in the future, along with the tightening of emission control on a global basis, the vehicle components such as emission devices (e.g. the abovementioned radiator) that could become disadvantageous when fraudulently replaced or removed, are expected to increase.

Therefore, even from the aspect of environmental preservation, it is very import-ant to ensure the prevention of illegally replacing proper components with fraudulent components. An example of the conventional art for this purpose is disclosed in Patent Reference 1.

A tamper detection system for a vehicle component disclosed in Patent Reference 1 in which a wired-type Anti-Tampering Device (a device that prevents tampering: ATD: Anti-Tampering Device (hereinafter referred to as the ATD)), along with a temperature sensor, is mounted to a radiator core that has been coated with an ozone catalyst.

This ATD is configured so that a specific component (radiator) of an automobile has an identifying unit attached for identifying the component (radiator), and the identifying unit and an ECU (electronic control unit) are coupled with a wire. In such cases, according to the ATD of the conventional art, the ECU confirms if the component is appropriately installed based on data provided by the identifying unit attached to the component.

More specifically, the ATD is essentially constructed in such a manner, that it cannot be removed from the radiator, and the identifying unit and the ECU communicate with each other via the wire. Here, the ATD includes a temperature sensor, and transmits a radiator core surface temperature signal to the ECU. The ECU, in turn, compares the radiator water temperature and the radiator core surface temperature received from the ATD, and confirms that both temperatures are in an appropriate relation to recognize that the specific radiator is attached. In this manner, the ECU confirms that the radiator is installed appropriately.

[Patent Reference 1] U.S. Pat. No. 6,695,473

However, the conventional wired ATD as disclosed in Patent Reference 1 has the following problems. First off, the wiring between the ATD and the ECU limits layout flexibility. In addition, because the ATD can be visually confirmed from an exterior view of the radiator, the ATD can make an easy target for tampering.

### SUMMARY OF THE INVENTION

The present invention is devised in view of the above noted problems, and an object thereof is to provide a vehicle component tamper detection system capable of effectively preventing tampering from occurring, and of facilitating and ensuring detection of such tampering when it occurs, while maintaining flexibility in layout and in manufacturing processes.

In order to achieve the above object, the present invention omits wiring between an RFID and an ECU by employing a small radio frequency identification integrated circuit (RFID) in order to wirelessly transmit signals to a receiver. With this configuration, the present invention contributes to increased layout flexibility as well as a reduction in assembly steps and manufacturing costs. Since the RFID is small, the RFID may be mixed in slurries and such, and disposed on an inconspicuous portion of a component that is the target of detection. Accordingly, it is possible to impede visual confirmation of the RFID, and thereby making the tampering itself difficult.

More specifically, the present invention is characterized in that, in an automobile, an identification chip capable of wirelessly identifying a component (proper component) of which such a vehicle is constructed (vehicle component) is attached to the vehicle component, and contrived in such a manner that it makes removal of the identification chip difficult. Therefore, replacement of the vehicle component with a fraudulent vehicle component may be detected by a wireless detection system based on detection as to whether or not the identification chip is attached to the vehicle component.

More specifically, the present invention provides the following.

(1) A vehicle component tamper detection system capable of detecting tampering of an automobile, the system including an identification chip that is attached to a vehicle component included in the automobile, and a detector that wirelessly detects the identification chip.

Here, “vehicle component” refers to any vehicle component that is required in the manufacturing of an automobile. There may also be one or more targets to which the identification chip is attached. Furthermore, the number of identification chips attached to a single vehicle component is not limited to just one, and a plurality of identification chips may also be attached to the vehicle component. In addition, the abovementioned “vehicle component” is not limited to a component with a particular function.

Furthermore, the detector that detects the identification chip may be attached to the automobile itself, or it may be attached external to the automobile. In cases in which the detector is attached to the automobile itself, the presence of the identification chip may be directly made known by an indication from the detector (for example, an indication on a display) attached to the automobile. Moreover, the detector may be considered as a kind of a repeater, and a different device may receive radio waves and such transmitted from the detector to perform the detection. With such a configuration, even if the detector is extremely small and the output of the radio wave from the detector is extremely low (when the output of the radio wave is weak), it is possible to perform the detection from distant locations by appropriately amplifying the output of the radio wave.

According to the abovementioned vehicle component tamper detection system, the vehicle component that is attached to the identification chip (vehicle component with an identification chip) may be detected wirelessly by detecting the presence of the identification chip. When the presence of the vehicle component with an identification chip is detected by the wireless detection system, then the component has not been tampered with. On the other hand, when the presence of the vehicle component with an identification chip cannot be confirmed by the wireless detection system, the component has been tampered with.

(2) The vehicle component tamper detection system according to (1), wherein the identification chip is provided with at least one of a concealment means for concealing the manner in which the identification chips is attached to the vehicle component, and a protective means for preventing the removal of the identification chip from the detector.

Examples of the “concealment means” includes micro-miniaturization of the identification chip so as to make the identification chip hard to see with the eye, or inconspicuous to the eye. By providing the concealment means, it is possible to make it difficult to visually observe the identification chip, and thus making the tampering itself difficult. In other words, providing the concealment means makes it hard to spot the device, and contributes to anti-tampering.

Furthermore, according to the present invention, the presence of a protective means makes it possible to prevent an act of evading tamper detection by removing an identification chip from a proper component to which the identification chip is originally attached, and attaching the removed identification chip to a fraudulent component (also referred to as an act of fraudulent part-switching).

The “concealment means” may be carried out in any form that conceals the manner in which the identification chip is attached to the vehicle component. Other than “micro-miniaturization of the identification chip” to a size that is hard to see as described above, the concealment means further includes making the identification chip undetectable by mixing the chip in a paint slurry or a paste, and making the identification chip inconspicuous by integrating the identification chip with the vehicle component or with a part of a design of the vehicle component design using different methods. It is also possible to make the identification chip hard to locate by mixing the identification chip into a similar pattern, or by forming a part of the vehicle component design with the identification chip along with dummy chips of the same size, shape, and color as the identification chip mixed into the paint slurry or the paste.

The protective means may be carried out in any manner that prevents the removal of the identification chip from the vehicle component. As the protective means, in addition to strengthening the attachment of the identification chip to the vehicle component (for example, a strong paste or bond), it is possible to integrate the identification chip with the vehicle component so as to form a part thereof by embedded-fixation to the vehicle component. Moreover, in some cases, a secure cover may be provided so that the identification chip cannot be removed.

The “protective means” and “concealment means” do not interfere each other, and may be provided so as to independently achieve a particular effect, or may be integrated to produce an additive effect or a synergistic effect. Accordingly, while the identification chip may be, for example, micro-miniaturized and attached firmly using a powerful adhesive (the respective functions of the “protective means” and “concealment means” are carried out independently), it is possible to achieve the effects of the “protective means” and “concealment means” simultaneously by, for example, attaching the identification chip under a covering member that covers the vehicle component.

(3) The vehicle component tamper detection system according to (1) or (2), wherein the identification chip includes a wireless transmitter that transmits predetermined radio waves, and the detector includes a wireless reception detector that detects reception of the radio waves transmitted from the transmitter of the identification chip.

(4) The vehicle component tamper detection system according to (1) or (2), wherein the identification chip is a radio frequency identification integrated circuit incorporating: an IC chip that stores at least information for identification; and an antenna that transmits and receives data from the IC chip.

(5) The vehicle component tamper detection system according to (4), wherein the identification chip is in a range of 0.35 mm to 0.5 mm at a longest side thereof.

Here, the radio frequency identification integrated circuit refers to the RFID (Radio Frequency Identification), which is also referred to simply as an electronic tag. The RFID typically incorporates an IC chip on the order of a couple millimeters, and an antenna for data transmission and reception. The IC chip stores the information for identifying items, which can be read out via the antenna using the radio waves.

Conventionally, barcodes have been used in identifying items. However, the radio frequency identification integrated circuit (RFID) has advantages such as the capability of reading plurality of items, durability, and the capability of reading data over a shield.

The RFID used in the present invention is not particularly limited in its shape, and may be in various shapes such as disc shapes and label shapes. In addition, the RFID is preferably waterproofed by lamination.

Furthermore, the RFID used in the present invention may include, in addition to a type that does not incorporate a power source and with which only reading of data is possible (read-only), a type that incorporates a power source, or a type with which both reading and writing of data is possible. However, in consideration of the risk of copying and alteration, the RFID is preferably of a read-only type.

Moreover, examples of a frequency band that may be used by the RFID of the present invention include a microwave band, a UHF band, a high-frequency band, and a low-frequency band. These frequency bands each have different communication ranges. Therefore, these frequency bands may be used independently, or more than one frequency band may be used in combination, as described later, by adapting the length of the antenna according to the frequency band to be used.

The abovementioned shapes and characteristics of the RFID and the frequency band to be used may be appropriately selected depending on the circumstances of actual detection.

(6) The vehicle component tamper detection system according to any one of (3) to (5), wherein the predetermined radio waves transmitted from the identification chip are in one or more frequency bands selected from a group consisting of a 135 kHz band, a 13.56 MHz band, an 800 MHz band, a 1.5 GHz band, a 1.9 GHz band, a 2.45 GHz band, a 5.8 GHz band, and a UHF band.

Here, when using the 800 MHz band or 1.5 GHz band, the system of the present invention may be used in combination with a mobile telephone, and when using the 1.9 GHz band, in combination with a PHS. Alternatively, it is possible to implement the present invention as a system incorporated in the mobile telephone or PHS, when using the corresponding frequency bands. In addition, when using the 135 kHz band, the system of the present invention may be used in combination with a common radio identification apparatus, and when using the 13.56 MHz band and 2.45 GHz band, in combination with a common wireless card system (an automated ticketing system employed in various transportation, a telephone card system for public telephones, and a wireless card system employed in an entrance or exit security control system for an office or a factory). It is also possible to implement the present invention as a system incorporated in the above apparatus or systems, when using the corresponding frequency bands.

Furthermore, when using the 5.8 GHz band, the present invention may be used in combination with an electronic toll collection system (ETC) that is growing popular, or implemented as a system incorporated in the ETC.

(7) The vehicle component tamper detection system according to any one of (1) to (6), wherein the vehicle component is one of a plurality of vehicle components to each of which a different type of the identification chip is attached.

In cases in which only one identification chip is attached, the tamper detection is to be performed on an automobile having a label indicating “environmentally friendly”, and such, to detect the presence of the identification chip. In other words, it is not possible to perform the tamper detection without confirming or recognizing a label indicating “environmentally friendly”, and such.

However, when attaching different types of identification chips, such as two identification chips of frequency bands that are different from each other, and provided that a regulation is set such that, “when an identification chip A is attached, an identification chip B is also required to be attached,” it is possible to determine that the tampering has been performed without confirming the indication of “environmentally friendly” if the identification chip A is detected while the identification chip B is not detected. Therefore, with such an arrangement, it is possible to perform the tamper detection only with wireless detection without confirmation by visual observation.

(8) The vehicle component tamper detection system according to any one of (1) to (7), wherein the vehicle component includes a radiator.

(9) The vehicle component tamper detection system according to any one of (1) to (8), wherein the vehicle component tamper detection system operates in combination with a temperature monitoring system that monitors the temperature of the vehicle component.

With this configuration, it is possible to simultaneously detect a problem in the vehicle component in addition to the tampering.

(10) A vehicle component, wherein a radio frequency identification integrated circuit for vehicle component tampering detection that detects tampering of the vehicle component is attached to the vehicle component in a manner in which visual confirmation of the radio frequency identification integrated circuit is difficult.

The “manner in which visual confirmation of the radio frequency identification integrated circuit is difficult” indicates a certain kind of counter-measure has been taken to make it difficult to find or visually observe the radio frequency identification integrated circuit attached to the vehicle component. Typically, such counter-measures include the “concealment means” as described above.

The present invention as described above provides the radio frequency identification integrated circuit (RFID) with a new application in tamper detection for the vehicle component. According to the present invention, a radio frequency identification integrated circuit (RFID) is disclosed that may be advantageously employed in manufacturing a vehicle component tamper detection system for a vehicle component (especially, a vehicle component relating to environmental improvements).

According to the vehicle component tamper detection system of the present invention as described above, employment of the wireless transmission method eliminates limitations in layout and increases layout flexibility. At the same time, this contributes to a decrease in the number of assembly steps and reductions in manufacturing costs. In addition, it is possible to provide the counter-measures that make it difficult to recognize the device from an exterior view.

By providing counter-measures that make it difficult to recognize the device from an exterior view, such as miniaturization of the device, it becomes even more difficult to spot the device, thus contributing to the prevention of the tampering.

Moreover, by attaching different types of identification chips to different vehicle components, respectively, it is possible to facilitate and ensure the detection of the tampering with external wireless recognition only, at a position distant from the automobile to be detected.

### BRIEF DESCRIPTION OF THE DRAWINGS

FIG. 1 is a block diagram showing one embodiment of a vehicle component tamper detection system according to the present invention;

FIG. 2 is a block diagram showing an embodiment in which an RFID is used in combination with a temperature sensor;

FIG. 3 is a flowchart showing an operational flow of the vehicle component tamper detection system illustrated in FIG. 1;

FIG. 4 is a flowchart showing an operational flow of the vehicle component tamper detection system illustrated in FIG. 2;

FIG. 5 is a block diagram illustrating an example of refinements for attaching the RFID to a component to be detected in a less visible manner;

FIG. 6A is a cross-sectional view illustrating a manner in which the RFID is attached to a surface of the component to be detected, and a paint is applied over the RFID; FIG. 6B is a view illustrating a technique for making a presence of the RFID difficult to be visually observed; and FIG. 6C is a view illustrating a manner in which the paint into which the RFID and a dummy RFID are mixed is pasted to a surface of the component to be detected;

FIG. 7 is a block diagram showing an embodiment in which the component to be detected according to the present invention is adapted as a radiator;

FIG. 8 is a block diagram showing an embodiment in which a receiver and an ECU are attached external to a vehicle;

FIG. 9 is a view illustrating a toll station provided with an ETC; and

FIG. 10 is a flowchart showing an operational flow of tamper detection performed simultaneously with detection of the ETC.

### DETAILED DESCRIPTION OF THE INVENTION

The following describes the preferred embodiments of the present invention with reference to the drawings.

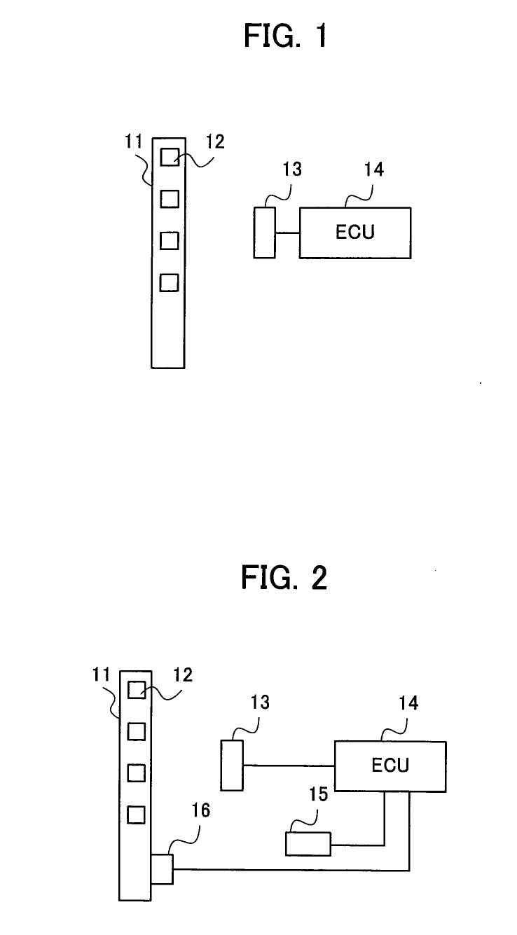

FIG. 1 is a block diagram showing one embodiment of a vehicle component tamper detection system according to the present invention. As shown in FIG. 1, in the vehicle component tamper detection system according to the present embodiment, a vehicle component 11 to be detected (hereinafter referred to as detection target component 11) is provided with a radio frequency identification integrated circuit (RFID) 12 attached thereto. In this embodiment, a radio signal from the RFID 12 attached to the detection target component 11 (or identification data stored in the RFID 12) is received wirelessly by a proper receiver 13 in a timely manner, and then transmitted to an ECU 14.

In cases in which, because the radio signal from the RFID 12 contains identification information, the ECU 14 detects whether or not a proper detection target component is mounted by reading the identification information from the RFID.

FIG. 2 is a block diagram showing an embodiment in which the RFID is used in combination with a temperature sensor. In FIG. 2, the radio signal from the RFID 12 attached to the detection target component 11 is received by the receiver 13, and then transmitted to the ECU 14. In addition, a noncontact temperature sensor 15 and a contact temperature sensor 16 transmit information on temperatures from portions related to the detection target component system 11 to the ECU 14.

Next, the ECU 14 reads the identification information from the RFID 12, and compares the values from the noncontact temperature sensor 15 and contact temperature sensor 16. Based on the results of the comparison, the ECU 14 detects whether or not the RFID 12 is mounted to the detection target component 11 in a normal manner, as well as whether or not the detection target component 11 is a particular proper component. Furthermore, as described later, the ECU 14 can easily identify fraudulent acts intending to deceive the ECU 14 by attaching the RFID 12 to the detection target component 11 in a fraudulent manner.

In this case, by providing the RFID with a temperature sensing function, it is possible to make the connection between the temperature sensor 16 and ECU 14 wireless. Typically, as described later, the detection target component 11 is a radiator. Furthermore, the noncontact temperature sensor 15 is typically a temperature sensor for measuring a radiator surface temperature, and R060 manufactured by CINO (metal surface temperature sensor) may be used as such a temperature sensor. In addition, the contact temperature sensor 16 is typically a temperature sensor for measuring a water temperature of an engine, such as a water temperature sensor manufactured by Nippon Seiki Co., Ltd may be used.

As described later in detail, in cases in which the RFID is used in combination with the temperature sensor, a correlation between the radiator surface temperature and engine water temperature is recorded in the ECU 14 in advance, for example, and the ECU 14 compares the values of the information on temperatures from the noncontact temperature sensor 15 and contact temperature sensor 16, to determine whether or not the contact temperature sensor 16 is properly attached to the radiator. Furthermore, based on the identification signal from the RFID 12, whether or not a specific type of radiator is mounted is also determined by the ECU 14.

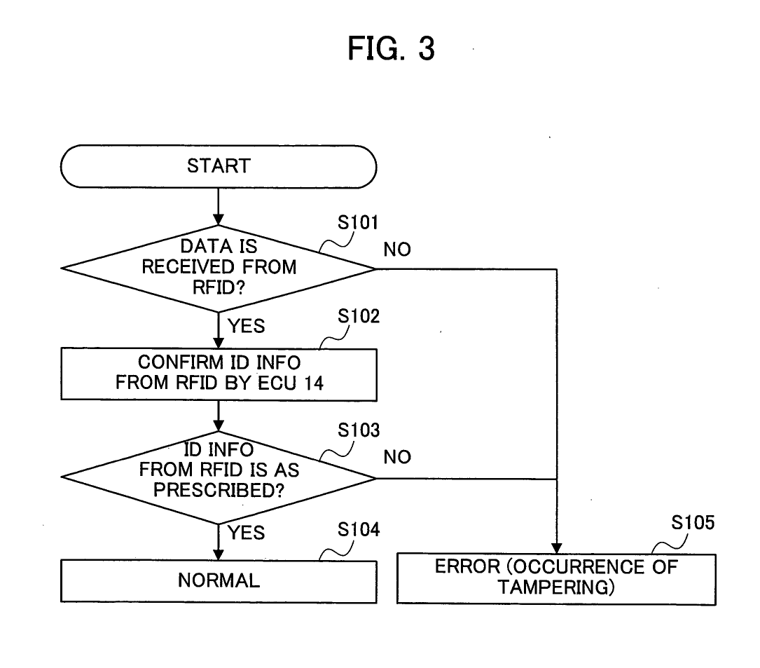

FIG. 3 is a flowchart showing an operational flow of the vehicle component tamper detection system illustrated in FIG. 1. Referring to this FIG. 3, an operation where only the RFID is employed is described.

First, whether or not the receiver 13 has received a signal from the RFID 12 mounted to the detection target component 11 is determined (S101). When the result of the determination is “YES”, the ECU 14 confirms the identification information from the RFID 12 (S102). Next, the ECU 14 determines whether or not the identification information from the RFID 12 received by the receiver 13 is as prescribed (S103). When the result of the determination is “YES”, it is determined to be normal (S104), and the operation is terminated.

On the other hand, when the result of the determination is “NO” at S101, it is determined that an error has occurred (the occurrence of tampering) (S105), and the operation is terminated. Furthermore, when the result of the determination is “NO” at S103, it is also determined that an error has occurred (occurrence of tampering) (S105), and the operation is terminated.

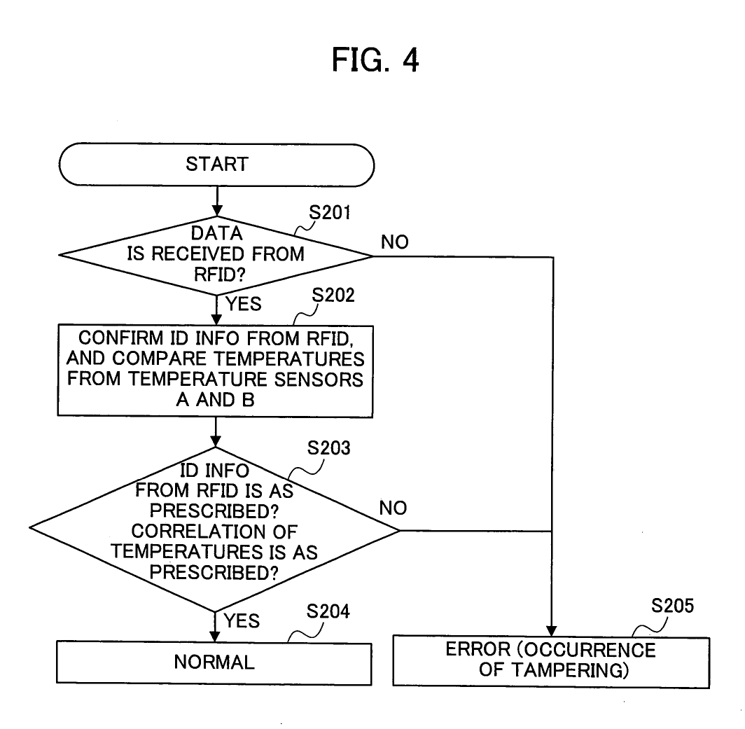

FIG. 4 is a flowchart showing an operational flow of the vehicle component tamper detection system illustrated in FIG. 2. Referring to this FIG. 4, an operation where the RFID is used in combination with the temperature sensor is described.

First, the ECU 14 determines whether or not the receiver 13 has received a signal from the RFID 12 mounted to the detection target component system 11 (S201). When the result of the determination is “YES”, the noncontact temperature sensor 15 and contact temperature sensor 16 transmit the information on temperatures at the portions relating to the system of the detection target component 11 to the ECU 14 (S202). The ECU 14 reads the identification information from the RFID 12, and compares the values from the noncontact temperature sensor 15 and contact temperature sensor 16, to determine whether or not the RFID 12 is mounted to the detection target component 11 in a normal manner, as well as whether or not the detection target component 11 is a specific proper component (S203). When the result of the determination is “YES”, it is determined to be normal (S204), and the operation is terminated.

On the other hand, when the result of the determination is “NO” at S201, it is determined that an error has occurred (the occurrence of tampering) (S205), and the operation is terminated. Furthermore, when the result of the determination is “NO” at S203, it is also determined that an error has occurred (the occurrence of tampering) (S205), and the operation is terminated.

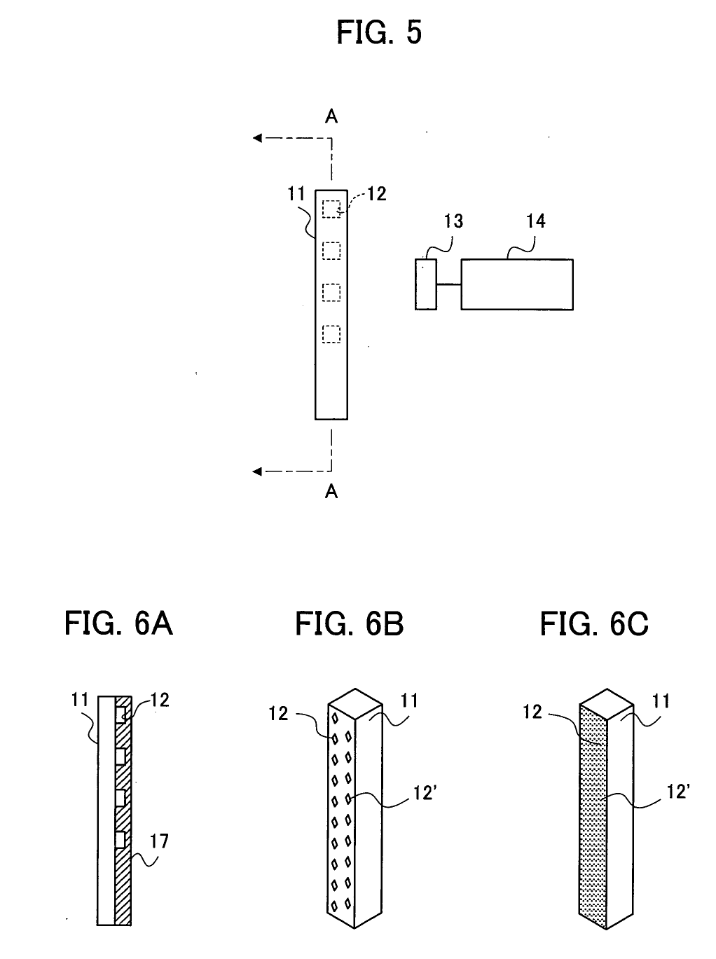

FIGS. 5 and 6 are diagrams respectively illustrating examples of refinements for attaching the RFID 12 to the detection target component 11 in a more inconspicuous manner. As a first example, a single detection target component 11 may be provided with one or a plurality of RFIDs 12. In this case, it is possible to make it difficult to visually confirm the RFID 12, by employing a method such as “applying a paint (slurry) into which the RFID 12 is mixed” as shown in FIG. 5. Making it difficult to visually confirm the RFID 12, in turn, makes it difficult to find out whether or not the RFID 12 is attached (i.e. whether or not the vehicle component tamper detection system has been provided). Therefore, the tampering triggered by the discovery of the sensor and such may be prevented from occurring.

Other examples of such refinements for preventing tampering by making visual confirmation of the sensor and such difficult include the following. As a second example, FIG. 6A illustrates a cross-sectional view taken along line A-A in FIG. 5. As shown in FIG. 6A, in this embodiment, the RFID 12 is attached to a surface of the detection target component 11, and a paint 17 is applied over the RFID 12. By applying the paint 17 over the RFID 12, the RFID 12 is concealed under the paint 17. This makes it difficult to visually confirm the RFID 12 from the surface of the component, and therefore, it is possible to prevent the tampering.

As a third example, in FIG. 6B, the RFID 12 in a rhombic shape and dummy chips (dummy RFIDs) 12′ that do not have any function for the RFID at all are attached to the surface of the detection target component 11 so as to intentionally form a pattern to make it difficult to visually confirm the RFID, by obstructing the exterior view.

Furthermore, as a fourth example, in FIG. 6C, a paint into which the RFID 12 and dummy RFIDs 12′ are mixed is applied to the surface of the detection target component 11. In this embodiment, both the RFID 12 and dummy RFIDs 12′ are as small as 0.4 square millimeters, and are hard to visually confirm. Accordingly, even when applied by being mixed in the paint, both the RFID 12 and dummy RFIDs 12′ can only be observed as dots or an appropriate filler mixed therein. Therefore, this also makes the visual observation of the RFID 12 difficult, and thus it is possible to prevent the tampering from occurring. The type of the refinements to be used for making the visual confirmation of the RFID 12 difficult should be determined by considering the type and manufacturability of the target component.

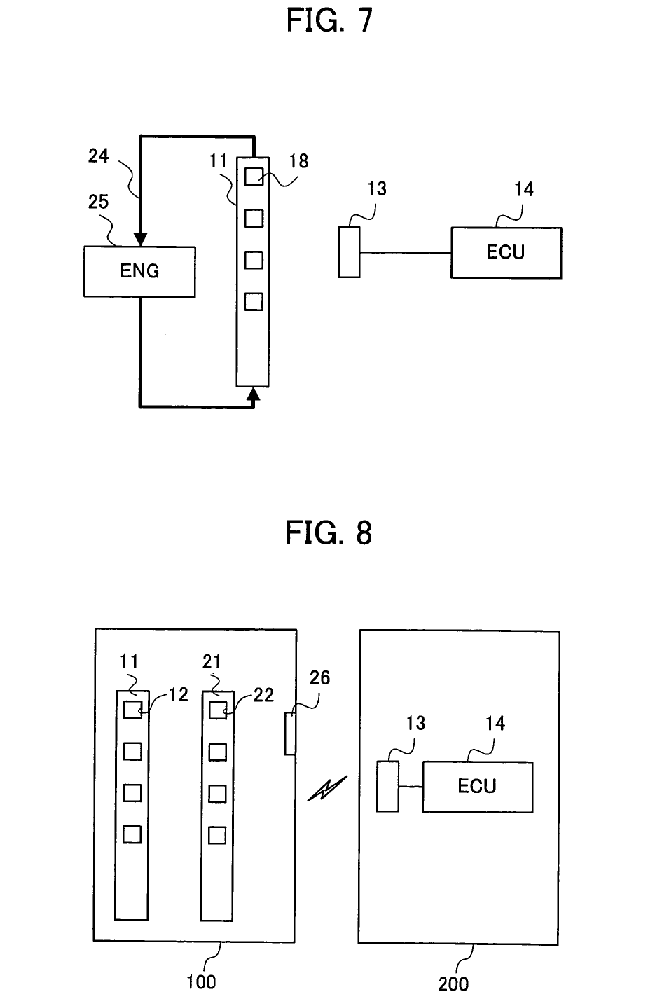

FIG. 7 is a block diagram showing an embodiment in which the detection target component 11 according to the present invention is adapted as a radiator. In this embodiment, the radiator 11 is coupled to an engine 25 via a cooling channel 24, and a RFID 18 with a temperature sensing function is attached to the surface of the radiator 11. A radio wave transmitted from this RFID 18 with a temperature sensing function is communicated to the ECU 14 via the receiver 13. Employing the RFID 18 with a temperature sensing function which enables simultaneous monitoring whether or not the radiator 11 is properly installed and whether or not the engine is properly cooled.

In this embodiment, the engine 25 is a common combustion (internal-combustion) engine. The engine 25 is provided with the cooling channel 24. The cooling channel 24 may be of a conventional type, and is coupled to the radiator 11.

In cases in which if the temperature of a coolant is at or below a predetermined threshold (e.g. 90 degrees Celsius), the coolant is diverted from the radiator 11 to a conduit (not shown) which is parallel to the radiator 11. The coolant flows back to the cooling channel 24 after dissipating heat while flowing through the main part of the radiator 11.

Moreover, it is well known that, in radiators that are environmentally friendly (improve the air quality), a part or an entirety of the conduit for the coolant located at the main part of the radiator 11 is coated with a catalytic material. This catalytic material is designed to convert environmentally harmful substances into environmentally harmless substances, and such a feature of purifying environmentally harmful substances is enhanced by the heat from the coolant that flows through the main part of the radiator 11.

Examples of environmentally toxic substances that may be purified by the abovementioned feature of purification of environmentally toxic substances includes airborne particles, ozone, carbon monoxide, nitrous oxide, VOC (volatile organic compound), HC (hydrocarbon), NMOG (non-methane organic gas), NOx, SO₂ (sulfur dioxide), and methane.

Here, in the present invention, the identification chip (RFID) 12 is attached to the radiator 11. The identification chip (RFID) 12 wirelessly transmits and receives data to and from the electronic control unit (ECU) 14 via an antenna and a transceiver.

In this embodiment, the ECU 14 inquires whether or not the radiator 11 is a catalyst coated radiator, at a constant interval, by wirelessly transmitting a response command signal periodically to the identification chip (RFID) 12. Furthermore, the identification chip (RFID) 12 sequentially responds to the inquiry by wirelessly transmitting a unique ID code assigned to the catalyst coated radiator. In cases in which the identification chip (RFID) 12 does not respond to the response command signal with an appropriate response, the ECU 14 determines that the radiator of the automobile is not one that has been coated with a catalyst. Substantially, the ECU 14 takes appropriate measures such as an internal memory setting for a malfunction code or turning on a malfunction indicator lamp.

It is known that, in cases in which a thermostat is opened and the coolant flows into the radiator 11, a temperature shows a very distinctive characteristic at the inlet to the radiator 11 (for example, see FIG. 4 of U.S. Pat. No. 6,695,473).

For example, the temperature at the inlet to the radiator 11 rises sharply in a very short period of time (about 4 seconds) from a temperature in an engine component of the automobile (around 40 degrees Celsius) up to around 90 degrees Celsius (the temperature at which the thermostat is designed to open). The ECU 14 periodically transmits the response command signal to the identification chip (RFID) 12, and can monitor this distinctive temperature rise. If this distinctive temperature rise is not observed while the automobile is warmed up for a plurality of times, the ECU 14 determines that the catalyst coated radiator 11 is not actually attached to the automobile. Subsequently, in order to display this malfunction, the ECU 14 takes appropriate measures including an internal memory setting for a malfunction code and/or turning on a malfunction indicator lamp.

Furthermore, with respect to the temperature in vicinity of the inlet to the radiator 11, the status, which closely corresponds to the temperature of the engine coolant, may be monitored, after the distinctive temperature rise occurs, and until the coolant stops flowing into the radiator 11. This relationship (that is, the close correspondence between the temperature of the engine coolant after the coolant starts to flow into the radiator and the temperature at the inlet to the radiator) may also be used as one method to sense whether or not the identification chip (RFID) 12 is actually attached to the radiator 11 in an accurate manner. The temperature of the engine coolant may be conveniently used due to the fact that the engine coolant temperature is already detected outside the radiator 11, typically in the engine 25, for the use of various engine controls.

However, the fact that the ECU 14 having received the right response to the response command signal does not necessarily ensure that the radiator is a catalyst coated radiator. A catalyst uncoated radiator is less expensive than a catalyst coated radiator and may be used as a replacement component for a type of vehicle or a department that does not require a catalyst coated radiator. Therefore, it is undeniable that this could incite fraudulent behavior intending to deceive the ECU 14.

A typical example of creative measures taken to deceive the ECU 14 in mistaking a catalyst uncoated radiator that has been attached as a repair component for one that has been coated with a catalyst is as follows. The identification chip (RFID) 12 that has never been installed in the radiator 11, or the identification chip (RFID) 12 that has been removed from the catalyst coated radiator 11 is obtained, and afterwards the identification chip (RFID) 12 is simply attached to the radiator 11. In this case, even if the radiator that is actually attached is a catalyst uncoated radiator, the ECU 14 transmits the response command signal to the identification chip (RFID) 12, and the identification chip (RFID) 12 subsequently responds that a catalyst coated radiator is attached to the automobile.

The present invention introduces two counter-measures in order to prevent such creative measures. One of the two counter-measures is, as explained in FIG. 2 and FIG. 4, to attach two or more types of sensors, and simultaneously monitor the physical values of the same detection target component. If the data detected by these two or more types of sensors differs, then it is concluded that the abovementioned creative measures have been employed in order to deceive the ECU.

Another counter-measure is, as explained in FIG. 6, to make the visual confirmation of the RFID 12 itself difficult, by applying refinements so that the RFID 12 is attached to the detection target component 11 in an inconspicuous manner. The identification chip (RFID) 12 cannot be removed from the radiator 11 coated with a catalyst if the RFID 12 is not found, and thus it is possible to prevent creative measures such as attaching the removed identification chip (RFID) 12 to the catalyst uncoated radiator.

In this regard, the conventional art (U.S. Pat. No. 6,695,473) intends to prevent such creative measures by providing a sensor (preferably a temperature sensor) near the identification chip (RFID) 12 so that physical environment in vicinity of the identification chip (RFID) 12 may be monitored. In the present invention, although the same conventional technique may certainly be adapted to achieve the same effect and to enhance reliability in fraud prevention, it is possible to effectively prevent such creative measures from occurring by adapting either or both of the above two counter-measures.

Using countermeasure similar to those used in conventional art (U.S. Pat. No. 6,695,473), in order to prevent the employment of creative measures for deceiving the ECU, the temperature sensor for the coolant temperature and the identification chip (RFID) 12 are disposed on a common integrated circuit mounted either on a single substrate or on a single circuit board, and are configured to be closely and inseparability joined to each other while being capable of operating independently. With this configuration, the temperature sensor may, independently from the identification chip (RFID) 12, sense the temperature near the identification chip (RFID) 12.

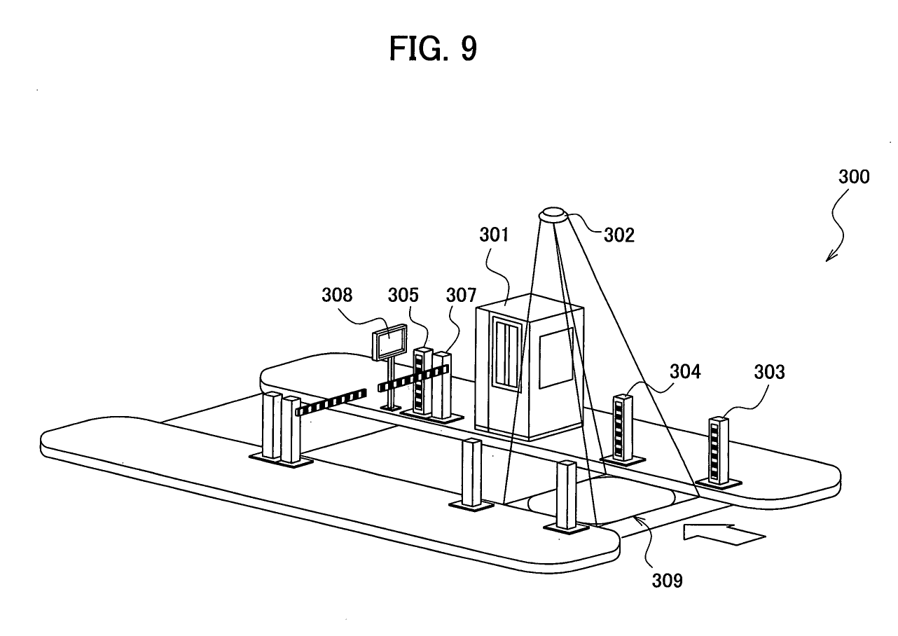

FIG. 8 is a block diagram showing an embodiment in which the receiver 13 and the ECU 14 are attached external to the vehicle. In this embodiment, an external equipment 200 shown in FIG. 8 is preferably a booth at a toll station provided with an ETC as shown in FIG. 9.

FIG. 9 is a view illustrating a toll station 300 provided with the ETC. In FIG. 9, the toll station 300 provided with the ETC (electronic toll collection system for toll roads) includes, in order to activate a wireless IC card system: a booth 301 that performs toll collection and other transactions: an antenna 302 that detects a vehicle inserted with an ETC card: three vehicle detectors 303, 304, and 305: and a gate 307. The toll station 300 provided with such an ETC system is further provided with a display unit 308 on which a detection result is displayed.

In this toll station 300, when a car enters a detection area 309 set between the vehicle detectors 303 and 304, the presence of an ETC card is detected by a radio wave transmitted from the antenna 302 and communicated to the booth 301. If an appropriate ETC card is inserted in the car, the payment is settled in the booth 301, and the gate 307 opens to let the car drive through. Once the passage of the car through the detection area 309 is confirmed, the processing for the car is reset. The result of the detection and transaction is displayed on the display unit 308.

In such cases, in this embodiment, the electric toll collection and the detection of tampering are performed at the same time by the ETC equipment. In the previously described embodiments, the radiator 11 has a function to improve the air quality. However, in the present invention, the detection target component is not limited to such a radiator, and a component for improving the air quality other than the radiator may also be used. The present invention may be advantageously adapted for a component having a function of reducing exhaust emissions of toxic substances from the automobile, such as a muffler (muffler supporting a catalyst that decomposes a component in exhaust emissions) as described below, for example.

In this embodiment, as shown in FIG. 8, a vehicle 100 is attached with the RFID 12 for the radiator and an RFID 22 for a muffler respectively for the radiator 11 and a muffler 21. In this embodiment, specific radiator and specific muffler are applied to the vehicle 100 in a single combination, and when the RFID 22 for the muffler is identified, the RFID 12 for the radiator is also expected to be identified. Therefore, a state in which the RFID 22 for the muffler is identified but the RFID 12 for the radiator is not identified indicates the fact that the radiator 11 has been tampered with. Furthermore, if the RFID 22 for the muffler is not detected when the RFID 12 for the radiator is detected, the muffler 21 is not mounted as a proper component, and the muffler has been tampered with. In such cases, it is possible to perform a determination in combination with location using a car navigation system, as described later.

In cases in which only one of the RFID 12 for the radiator and the RFID 22 for the muffler is identified as the identification chip (RFID), without visual confirmation, it is not easy to determine whether it is part of the original design or because of tampering that the vehicle is not attached with a proper component. In other words, if a new regulation were introduced one day that every vehicle must be installed with the catalyst coated radiator 11 that would favorably affect the environment, and if the catalyst coated radiator 11 were mounted on every new car as a “proper component” thereafter, there is no telling whether or not cars that had been sold up until then (used cars) had this specific radiator 11 (proper component) installed. In such cases, it would be extremely difficult to determine whether the car is tampered or not from the booth 301 of the toll station, for example, without visually observing the exterior of the car. However, mounting two different RFIDs enables immediate confirmation of when one of the two RFIDs is not detected while the other is detected.

In this embodiment, a radio wave from the RFID 22 for the muffler that has been amplified via a repeater 26 is transmitted. By using this repeater 26, it is possible to augment power output and expand detection distance. It is preferable to use the repeater 26 that operates in conjunction with the car navigation system. In this way, it is possible to utilize GPS (Global Positioning System) that is installed in the car navigation system to simultaneously transmit the location information of the vehicle (location information obtained by GPS). By transmitting and receiving the location information via the repeater 26, it is possible to locate geographic position of the vehicle. At the same time, the detection of whether or not the RFID 12 for the radiator is attached to the radiator 11 is performed via the repeater 26. Therefore, the detection of the tampering and geographical positioning are performed simultaneously, and subsequently, it is possible to locate a geographic position of a tampered vehicle or to track the tampered vehicle.

At the toll station 300 shown in FIG. 9, providing the antenna 302 with the receiver 13 according to the present embodiment mounted therein enables ETC related detection as well as tamper detection. When neither detection presents a problem, an amount paid at the ETC and an indication that there is no tampering (such as “qualified car”) are displayed on the display unit 308.

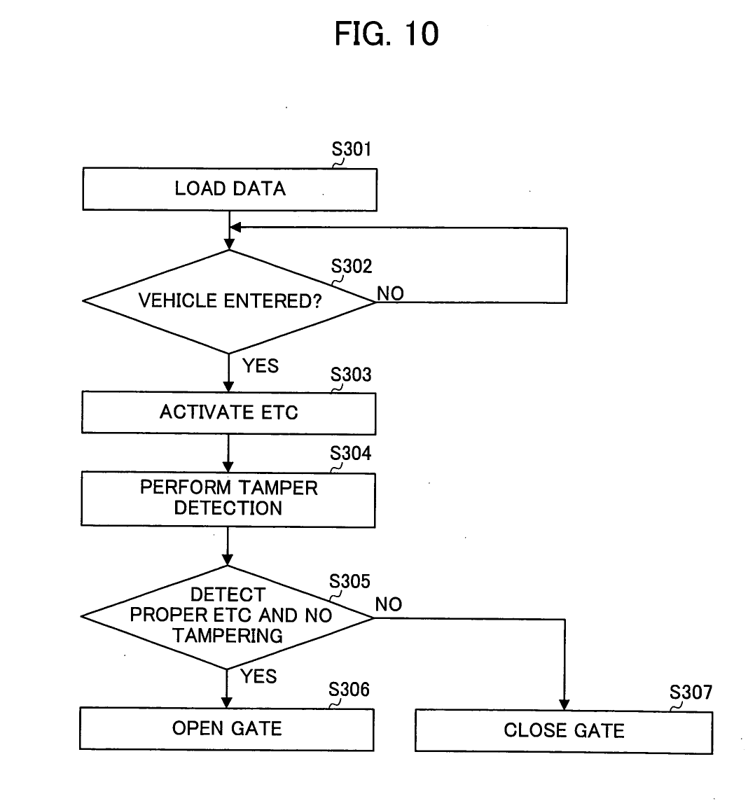

FIG. 10 is a flowchart showing an operational flow of the tamper detection performed simultaneously with the detection of the ETC. As shown in this FIG. 10, first, data is loaded (S301), and subsequently, it is confirmed whether or not a vehicle has entered the detection area 309 (S302). When the entrance of the vehicle is confirmed, the ETC is activated (S303), and the tamper detection is performed at the same time (S304). Next, it is determined whether or not the payment has been settled appropriately at the ETC, and whether or not tampering has occurred (S305). When a result of the determination indicates no problem in both conditions, the gate opens (S306). However, when the result of the determination indicates a problem in either of the conditions (that is, either when the payment has not been appropriately made at the ETC, or tampering has been detected, even if the payment has been made appropriately at the ETC), the gate remains closed (S307).

While preferred embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

What is claimed is:

1. A vehicle component tamper detection system capable of detecting tampering of an automobile, the system comprising:
an identification chip that is attached to-a vehicle component included in the automobile; and
a detector that wirelessly detects the identification chip.

2. The vehicle component tamper detection system according to claim 1, wherein
the identification chip is provided with at least one of a concealment means for concealing the manner in which the identification chips is attached to the vehicle component, and a protective means for preventing the removal of the identification chip from the detector.

3. The vehicle component tamper detection system according to claim 1, wherein
the identification chip includes a wireless transmitter that transmits predetermined radio waves, and the detector includes a wireless reception detector that detects reception of the radio waves transmitted from the transmitter of the identification chip.

4. The vehicle component tamper detection system according to claim 1, wherein
the identification chip is a radio frequency identification integrated circuit incorporating: an IC chip that stores at least information for identification; and an antenna that transmits and receives data from the IC chip.

5. The vehicle component tamper detection system according to claim 4, wherein
the identification chip is in a range of 0.35 mm to 0.5 mm at a longest side thereof.

6. The vehicle component tamper detection system according to claim 3, wherein
the predetermined radio waves transmitted from the identification chip are in one or more frequency bands selected from a group consisting of a 135 kHz band, a 13.56 MHz band, an 800 MHz band, a 1.5 GHz band, a 1.9 GHz band, a 2.45 GHz band, a 5.8 GHz band, and a UHF band.

7. The vehicle component tamper detection system according to claim 1, wherein
the vehicle component is one of a plurality of vehicle components to each of which a different type of the identification chip is attached.

8. The vehicle component tamper detection system according to claim 1, wherein
the vehicle component includes a radiator.

9. The vehicle component tamper detection system according to claim 1, wherein
the vehicle component tamper detection system operates in combination with a temperature monitoring system that monitors the temperature of the vehicle component.

10. A vehicle component, wherein
a radio frequency identification integrated circuit for vehicle component tampering detection that detects tampering of the vehicle component is attached to the vehicle component in a manner in which visual confirmation of the radio frequency identification integrated circuit is difficult.
